(19) United States
(12) Patent Application Publication
(10) Pub. No.: US 2010/0304799 A1
(43) Pub. Date: Dec. 2, 2010

(54) SLIDE FLIP MECHANISM AND CONFIGURATION FOR A MOBILE DEVICE

(76) Inventors: Kwok Ching LEUNG, Richmond Hill (CA); Archer Chi Kwong WUN, North York (CA); Jason Tyler GRIFFIN, Kitchener (CA)

Correspondence Address: BENNETT JONES LLP, 3400 ONE FIRST CANADIAN PLACE, PO BOX 130, TORONTO, ON, M5X 1A4, CA

(21) Appl. No.: 12/471,671

(22) Filed: May 26, 2009

(51) Int. Cl. H04M 1/00

(52) U.S. Cl. 455/575.3

(57) ABSTRACT

A mobile device comprising a first component, a second component and a slider flip mechanism configured to operatively couple the first and second components. The first component may be configured with keys and the second component may be configured with a display. According to an embodiment, the slider flip mechanism comprises a hinge and a slide member, and is configured for sliding the second component relative to the first component from a slide-in position to a slide-out position, for example, to expose one or more of the keys. The slider flip mechanism is configured to also allow flipping of the second component relative to the first component from a flipped-closed position to a flipped-open position, for example, to expose the display. According to an embodiment, the slide member includes a camera component and is configured to protect and/or deactivate the camera component when the slide member is in the slide-in position.

### FIELD OF THE APPLICATION

The present application relates to mobile devices, and more particularly to a slider flip mechanism and configuration for a mobile communication device.

### BACKGROUND OF THE APPLICATION

The functionality associated with mobile communication devices continues to increase and the convergence of voice and data functions is becoming the norm. Mobile communication devices are typically equipped to provide voice, email, text messaging and web browsing functions. In addition, mobile communication devices are also available that include MP3 capabilities, a digital camera and/or integrated GPS functionality. With the increased functionality and features being put into mobile communication devices, there comes the need for expanded user controls for data entry and navigation. As a result, mobile communication devices are typically configured with a keypad for entering telephone numbers and/or text and alphanumeric characters, function keys/buttons and navigation tools, such as, menu keys, a trackball, scroll wheel and the like.

In order to be useful, the functionality and controls associated with the mobile communication device must be easily accessible by a user and the ergonomics of the mobile communication device become an important consideration for a user in order to handle the increasing functionality and feature set.

Accordingly, there remains a need for improvements in the art.

### BRIEF DESCRIPTION OF THE DRAWINGS

Reference will now be made to the accompanying drawings which show, by way of example, embodiments according to the present disclosure, and in which:

FIG. 1 is a perspective view of a mobile communication device with a slider flip mechanism in a closed position according to an embodiment;

FIG. 2 is a further perspective view of the mobile communication device of FIG. 1 in a slide-out position;

FIG. 3 is a further perspective view of the mobile communication device of FIG. 1 in a slide-out and flipped open position;

FIG. 4 is a further perspective view of the mobile communication device of FIG. 1 in a flipped open position;

FIG. 5 is a perspective view of a slide and a C-channel receiving profile according to an embodiment; and

FIG. 6 is a sectional view of the slide and C-channel receiving profile shown in FIG. 5 and taken along line 5-5.

Like reference numerals indicate like or corresponding elements in the drawings.

### DETAILED DESCRIPTION OF THE EMBODIMENTS

The present disclosure is directed generally to a mobile communication device or handheld device with a slider flip mechanism and configuration.

According to one embodiment, the present disclosure comprises a mobile device comprising: a first component; a second component; a slider flip mechanism; wherein the slider flip mechanism is configured to operatively couple the first component to the second component; and wherein the slider flip mechanism is configured for sliding the second component relative to the first component from a slide-in position to a slide-out position, and wherein the slider flip mechanism is configured for flipping the second component relative to the first component from a flipped-closed position to a flipped-open position in the slide-in position or in the slide-out position.

According to another embodiment, the present disclosure comprises an apparatus for connecting a mobile communication device base component with a cover component, the apparatus comprises: a slide member operatively coupled to the base component; a hinge operatively coupled to the slide member and being configured for engaging the cover component; the slide member being configured for sliding the display component relative to the base component from a slide-in position to a slide-out position; and the hinge being configured for flipping the cover component relative to the base component from a flipped-closed position to a flipped-open position in the slide-in position or in the slide-out position.

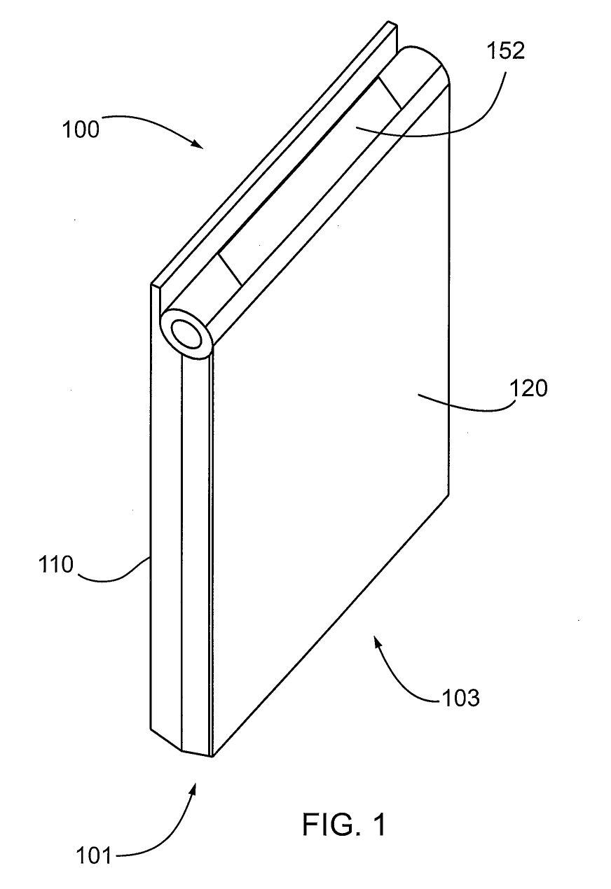

Reference is first made to FIG. 1, which shows a mobile device according to an embodiment and indicated generally by reference 100. According to an embodiment, the mobile device 100 comprises a mobile communication device such as a BlackBerry™ handheld device or a cellular phone or communication device or other type of handheld device.

According to an embodiment shown in FIG. 1, the mobile device 100 comprises a first member or base or base component 110 and a second member or cover or cover component 120. Although other configurations may be suitable, the cover 120 has a shape similar to the shape of the base 110.

Referring now to FIGS. 1-4, the base 110 includes a keypad or keyboard 112, and the cover 120 includes a display module 122 provided on an inner surface of the cover 120 and visible when the device 100 is in a flipped-open configuration. According to an embodiment, the keypad 112 comprises a dual-function style keyboard with a telephone dial pad (i.e. for numeric entry) and a QWERTY style keyboard for entering alphanumeric characters, e.g. for text messaging or email applications, and it will be appreciated that other keyboards may be appropriate, such as a reduced QWERTY, AZERTY or QWERTZ keyboard, among others. It is contemplated that the keyboard 112 could be a physical keyboard with depressible keys, or a touch screen keyboard, as known in the art.

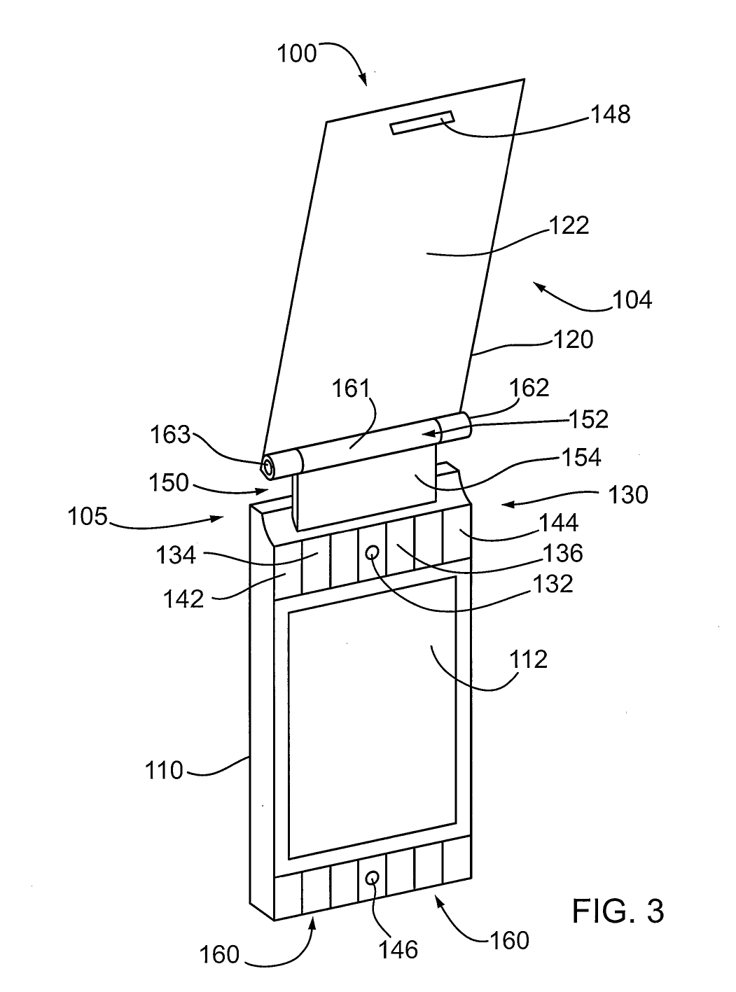

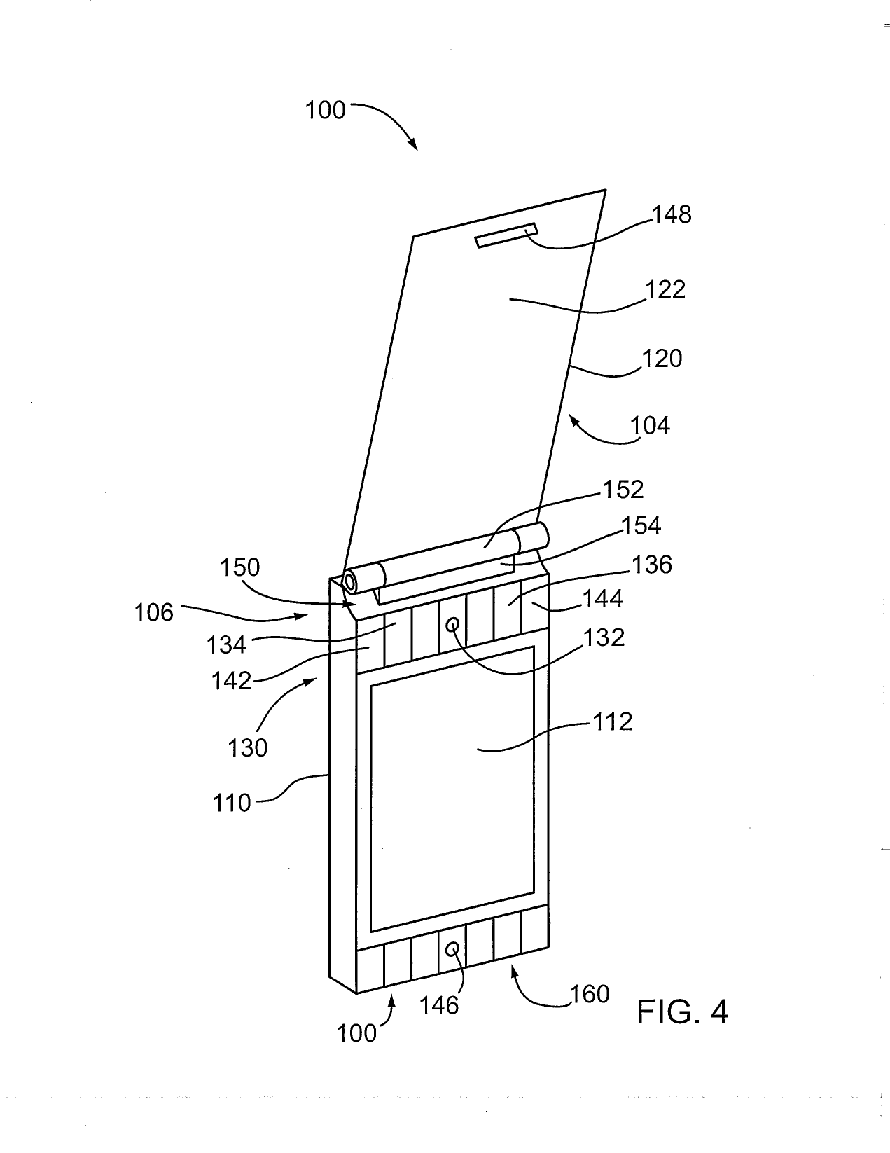

According to an embodiment, the base 110 further includes navigation tools or controls and/or telephony keys or controls, for example as shown in FIG. 3, and indicated generally by reference 130. Alternatively, the telephony keys and/or navigation controls 130 may be situated or configured (not shown) with the cover 120. The navigation controls include a trackball 132 (or other type of pointing device or mechanism), a menu key 134 and an escape or return key 136, for example as depicted in FIGS. 3 and 4. The telephony keys or controls include a send or call key 142 and an end call key 144, for example as depicted in FIGS. 3 and 4. It will be appreciated that other key, button or control configurations are possible according to other embodiments or other implementations.

Still referring to FIGS. 3 and 4, the base 110 includes a microphone or similar transducer component 146, and the cover 120 includes a receiver (e.g. speaker) or similar transducer component 148. The mobile device 100 further includes function keys indicated generally by reference 160 on a lower portion of the base 110. According to an embodiment, the functionality or features associated with the function keys 160 are user programmable, although it will be appreciated that the functions of the function keys 160 may be pre-selected for the user by, for example, the device manufacturer or the user's wireless service provider.

According to an embodiment, the mobile device 100 is implemented with voice and data communication functionality. The mobile device 100 comprises a central processing unit or CPU (not shown) that operates under the control of a program (i.e. stored program control) and executes code or instructions, in the form of firmware or software, stored in program memory. The CPU is also provided with data memory. In known manner, the CPU is also operatively coupled to the keyboard 112, the display module 122 and the trackball 132, and an audio transducer or speaker 148. In addition to the program executable code provided for performing the functions associated with the operation of the mobile device 100, the program memory includes other programs or applications, for example, a browser program. The browser program allows a user to access web pages on the Internet using the mobile device 100, e.g. utilizing a graphical user interface, comprising, for example, the keyboard 112 and the display module 122 and/or the trackball 132. The mobile device 100 includes a RF, demodulation/modulation and decoding/coding circuits (not shown), and a suitable RF antenna (not shown). The RF demodulator/modulator and decoder/coder circuits and the RF antenna are operatively coupled to the CPU and provide an interface for wireless communication with the wireless network. The particular implementation details of the voice and data functions and RF circuits will be within the understanding of those skilled in the art, and are therefore not described in further detail.

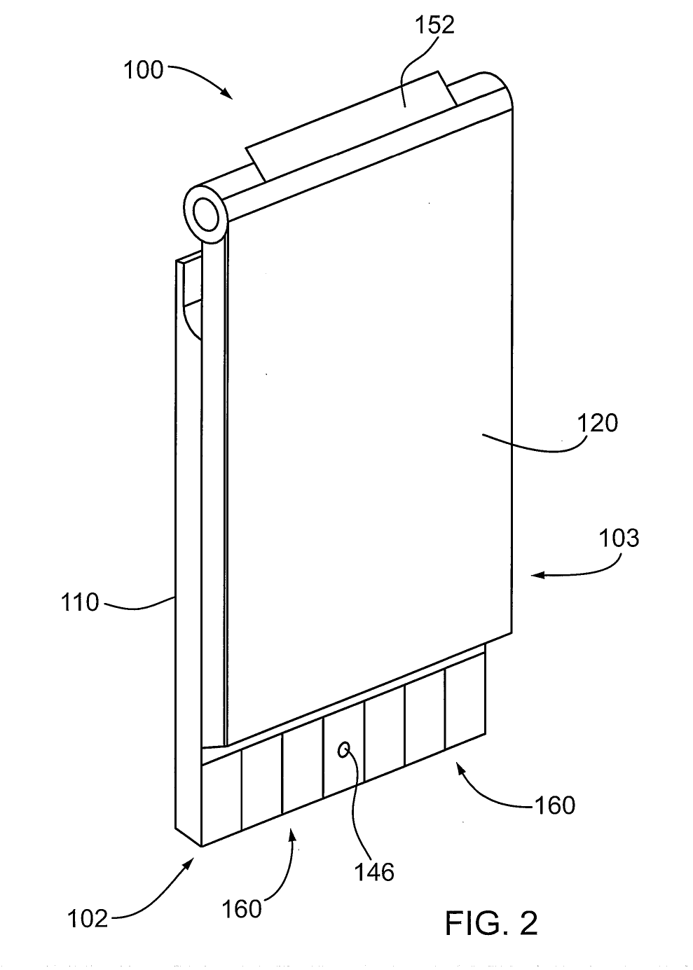

Referring to FIGS. 3 and 4, the cover 120 is operatively coupled to the base 110 via a slider flip mechanism indicated generally by reference 150. According to an embodiment, the slider flip mechanism 150 is configured to allow the cover 120 to slide with respect to the base 110 between a slide-in position indicated generally by reference 101 in FIG. 1 and a slide-out position indicated generally by reference 102 in FIG. 2 (and reference 105 in FIG. 3). The slider flip mechanism 150 is also configured to allow the cover 120 to flip with respect to the base 110 between a flipped-closed position indicated generally by reference 103 in FIG. 1 and a flipped-open position indicated generally by reference 104 in FIG. 4. In addition, the slider flip mechanism 150 is configured to allow the cover 120 to flip with respect to the base 110 when the base 110 is in the slide-out position 102 (FIG. 2) between the flipped-closed position 103 indicated in FIG. 2 and the flipped-open position 104 (FIG. 3). Further, the slider flip mechanism 150 is also configured to allow the cover 120 to be manipulated in the flipped-open 104 and the slide-out 105 positions shown in FIG. 3 and slid into a slide-in position indicated generally by reference 106 as shown in FIG. 4. In other words, the user can easily maneuver the device 100 into various positions or configurations to suit the application, as will be described in further detail below. For example, the present slider flip mechanism 150 does not require the user to place the device 100 in the slide-in position 106 prior to moving the cover into the flipped-closed position 103. Rather, the user can move the cover 120 from the flipped-open position 104 to the flipped-closed position 103 from either the slide-in or slide-out positions 106, 105, respectively.

According to an embodiment, when the mobile device 100 is in the flipped-open position 104 shown in FIGS. 3 and 4, the display screen 122 is activated. Alternatively, when the mobile device 100 is in the flipped-closed position 103 shown in FIGS. 1 and 2, the display screen 122 is turned off or operated in a “sleep mode”, as will be familiar to one skilled in the art. It is contemplated that such a configuration will conserve the battery life of the device.

To enable the above-described manipulation of the device 100, the slider flip mechanism 150 comprises a hinge 152 and a slide member or slide 154. The hinge 152 is configured to engage an end of the cover 120 and allows the cover to rotate approximately 180 degrees, or another suitable angle, as desired, relative to the base 110. The hinge 152 comprises a hinge member or component 161 connected to the slide member 154 and a mating or matching hinge member or component 162 connected to the cover 120. According to an embodiment, the hinge members 161 and 162 are coupled together to form the hinge 152 (for example, using a hinge pin 163 or other similar component).

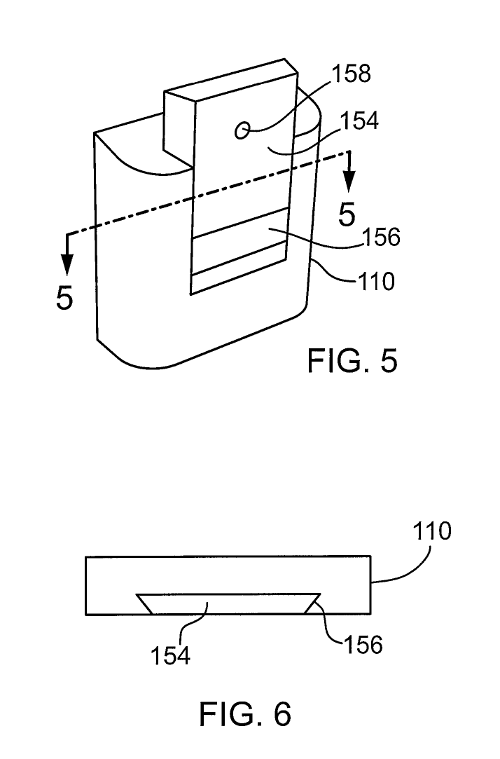

Turning now to FIGS. 5 and 6, the slide member 154 is configured for being received in a channel or recess 156 configured in the base 110. According to an embodiment, the recess 156 comprises a C-channel configuration, which is defined in the base 110. The slide 154 is further configured to allow the cover 120 and/or the base 110 to move linearly with respect to each other from the slide-in position 101, 106 in FIGS. 1 and 4, respectively, to the slide-out position 102, 105 in FIGS. 2 and 3, respectively, and vice versa. According to an embodiment, the slide 154 can be configured to include a camera component 158 (FIG. 5), for example, comprising a camera lens or a camera. When the slide member 154 is in the slide-in position 101 or 106, i.e. not extended, the camera component 158 is not exposed and protected. When the user manipulates the device to the slide-out position 102 or 105, the camera component 158 is exposed and can be operated by the user. According to another aspect, the camera component 158 is configured to be turned off or deactivated in the slide-in position 101 or 106 and turned on or active in the slide-out position 102 or 105. It will be appreciated that other slide or guiding mechanisms may be utilized and the particular implementation details will be within the knowledge of one skilled in the art. It is further appreciated that the present device 100 is not limited to providing a camera component 158 on the slide member 154 and that alternative components may be provided on the slide member 154, such as additional keys, navigational components, or the like.

According to one aspect, when the mobile device 100 is flipped closed and slid in (FIG. 1), the user is prevented from inadvertently hitting keys or buttons, which may, for example, initiate dialing of a phone call. According to another aspect, the user of the mobile device 100 may access function keys 160 on the lower portion of the base 110 when the mobile device 100 is flipped closed by sliding the cover 120 relative to the base 110 (i.e. into the slide-out position 102 depicted in FIG. 2) through the use of the slider flip mechanism 150. This can allow the user to access the function keys 160 when the mobile device 100 is in the user's pocket (i.e., if the device 100 is placed into the user's pocket with the hinge 150 facing away from them and the lower portion of the base 110 facing towards them), since the mobile device 100 need not be flipped open to access the function keys 160. Such a configuration also allows the user to access the function keys 160 at any time an application using those keys is desired, such as for playing media, for example, without the need to first flip open the device.

While not shown in the drawings, it is also contemplated that the device 100 could have an outer display screen provided on an outer surface of the cover 120, providing a secondary display to the user. Such an outer display screen could indicate the time, number of new messages, battery strength and signal strength, among others, to the user, without the need for the user to flip open the cover 120 relative to the base 110. Further, when the user manipulates the cover 120 into the slide-out position 102 (FIG. 2), the user can access the function keys 160 to operate the outer display screen. For example, the user could use the function keys to scroll through new messages or missed calls, to change the volume, or to change the time on the device, among other things.

While the slider flip mechanism and configuration has been described in the context of a mobile communication device, it will be appreciated that the configuration is suitable for other types of handheld devices or portable communication or data devices.

The present disclosure may be embodied in other specific forms without departing from the spirit or essential characteristics thereof. Certain adaptations and modifications of the disclosure will be obvious to those skilled in the art. Therefore, the presently discussed embodiments are considered to be illustrative and not restrictive, the scope of the disclosure being indicated by the appended claims rather than the foregoing description, and all changes which come within the meaning and range of equivalency of the claims are therefore intended to be embraced therein.

What is claimed is:

1. A mobile device comprising:
a first component;
a second component;
a slider flip mechanism;
wherein said slider flip mechanism is configured to operatively couple said first component to said second component; and
wherein said slider flip mechanism is configured for sliding said second component relative to said first component from a slide-in position to a slide-out position, and wherein said slider flip mechanism is configured for flipping said second component relative to said first component from a flipped-closed position to a flipped-open position in said slide-in position or in said slide-out position.

2. The mobile device as claimed in claim 1, wherein said first component is configured with a plurality of keys, and one or more of said plurality of keys are accessible in said slide-out position.

3. The mobile device as claimed in claim 1 wherein said second component includes a display, and said display is viewable in said flipped-open position.

4. The mobile device as claimed in claim 1, wherein said slider flip mechanism comprises a hinge and a slide member operatively coupled to said hinge.

5. The mobile device as claimed in claim 4, wherein said hinge comprises a hinge member connected to said second component and another hinge member connected to one end of said slide member, and a hinge pin for operatively coupling said hinge members together.

6. The mobile device as claimed in claim 4, wherein said slide member is configured for being received in a recess defined in the first component.

7. The mobile device as claimed in claim 6, wherein said recess comprises a C-channel configured in said first component.

8. The mobile device as claimed in claim 4, wherein said hinge engages the second component.

9. The mobile device as claimed in claim 1, wherein said slide member includes a camera component.

10. The mobile device as claimed in claim 9, wherein said camera component is in a covered state when said slider flip mechanism is said slide-in position.

11. The mobile device as claimed in claim 10, wherein said camera component is operable when said slider flip mechanism is in said slide-out and said flipped-open positions.

12. The mobile device as claimed in claim 3, wherein said display is configured to be operable when said slider flip mechanism is in said flipped-open position.

13. An apparatus for connecting a mobile communication device base component with a cover component, said apparatus comprising:
a slide member operatively coupled to the base component;
a hinge operatively coupled to said slide member and being configured for engaging the cover component;
said slide member being configured for sliding said cover component relative to said base component from a slide-in position to a slide-out position; and
said hinge being configured for flipping said cover component relative to said base component from a flipped-closed position to a flipped-open position in said slide-in position or in said slide-out position.

14. The apparatus as claimed in claim 13, wherein said hinge comprises a hinge member connected to said slide member and another hinge member connected to the cover component, said hinge members being operatively coupled together.

15. The apparatus as claimed in claim 14, wherein the base member includes a C-channel configured for operatively receiving said slide member.
